(19) United States
(12) Patent Application Publication
(10) Pub. No.: US 2019/0359798 A1
(43) Pub. Date: Nov. 28, 2019

(54) RUBBER COMPOSITION AND CONDUCTIVE ROLLER USING THE SAME

(71) Applicant: SUMITOMO RUBBER INDUSTRIES, LTD., Hyogo (JP)

(72) Inventor: HIDETOSHI ICHIGE, Hyogo (JP)

(73) Assignee: SUMITOMO RUBBER INDUSTRIES, LTD., HYOGO (JP)

(21) Appl. No.: 16/395,265

(22) Filed: Apr. 26, 2019

(30) Foreign Application Priority Data
May 23, 2018 (JP) 2018-098556

(51) Int. Cl. C08L 9/06; C08L 71/03; C08K 3/22; G03G 15/08; C08K 3/34

(52) U.S. Cl. CPC C08L 9/06; C08L 71/03; C08K 3/22; G03G 15/0806; G03G 2215/00683; C08L 2205/025; C08L 2205/03; C08K 2003/2296; C08K 3/34

(57) ABSTRACT

There is provided a rubber composition which is obtained by combining an appropriate liquid rubber with a blend system of rubbers having low compatibility that is compatible with advances in image forming devices, and which has excellent processability and is unlikely to cause contamination and the like of a photoreceptor, has favorable characteristics as a rubber, and can form a roller main body of a conductive roller and a conductive roller having a roller main body constituted by the rubber composition. In the rubber composition, 3 to 30 parts by mass of fillers are added to rubbers including an epichlorohydrin rubber, E-SBR, and 3 to 15 parts by mass of LIR. A conductive roller includes a roller main body constituted by the rubber composition.

### CROSS-REFERENCE TO RELATED APPLICATION

This application claims the priority of Japan patent application serial no. 2018-098556, filed on May 23, 2018. The entirety of the above-mentioned patent application is hereby incorporated by reference herein and made a part of this specification.

### BACKGROUND

### Technical Field

The disclosure relates to a rubber composition and a conductive roller having a roller main body formed using the rubber composition.

### Description of Related Art

For example, in image forming devices using electrophotography such as laser printers, electrostatic copying machines, plain paper facsimile machines, and a multifunctional machine thereof, conductive rollers are used in processes of charging, developing, transferring, and cleaning.

As the conductive roller, for example, a conductive roller having a roller main body formed by molding a rubber composition having conductivity into a cylindrical shape and performing crosslinking and a shaft which is made of a metal or the like and is inserted into and fixed to a through-hole at the center of the roller main body is used.

In order to impart stable conductivity to the conductive roller, as a rubber forming the rubber composition, for example, an ion-conducting rubber such as an epichlorohydrin rubber is used.

In addition, regarding the rubber, an ion-conducting rubber and other rubbers such as a diene rubber may be blended together.

When these other rubbers are blended, contamination of a photoreceptor due to components and the like generated when the ion-conducting rubber is crosslinked is minimized, and it is possible to finely adjust a roller resistance value of the conductive roller, with its required value different for each application of the conductive roller and for each image forming device in which it is incorporated.

In addition, it is possible to minimize filming in which a toner is adhered to the outer circumferential surface of the roller main body and for the rubber to impart favorable characteristics to the roller main body.

That is, it is possible to improve the flexibility of the roller main body and reduce a compression set.

Thus, when the compression set is reduced, it is possible to minimize partial deformation (set) in a part of the roller main body in contact with a photoreceptor, for example, when the image forming device is stopped for a certain period while the roller main body is in contact with the photoreceptor.

However, the ion-conducting rubber and other rubbers may have low compatibility depending on combinations thereof.

Thus, even if such rubbers having low compatibility are kneaded together with a crosslinking component and other additives using a roll mill or the like in order to prepare a rubber composition, the rubber may not be able to be smoothly wound around the roller and may not be able to be smoothly kneaded, and workability of kneading may decrease in some cases.

In addition, when the prepared rubber composition is extruded and molded into a cylindrical component that forms the roller main body, severe irregularities may occur on the extruded surface of the extruded and molded cylindrical component, that is, the outer circumferential surface of the cylindrical component and the inner circumferential surface of the through-hole.

However, it is not possible to change types and proportions of rubbers to be blended in many cases due to restrictions in an electrophotographic process.

In this case, currently, for example, a certain degree of processability is secured by increasing an amount of fillers contributing to kneading of the rubbers.

Incidentally, since the roller main body of the conductive roller is in slidable contact with a developing blade or a seal part of a cartridge, the roller main body is required to be as flexible as possible in many cases in order to minimize wear and the like of these members.

In addition, it is preferable that an appropriate nip width during contact with a photoreceptor and the like be secured and the roller main body be as flexible as possible.

Therefore, there is a limit on a method of increasing an amount of fillers causing the flexibility of the roller main body after crosslinking to deteriorate.

Moreover, the performance of image forming devices has tended to become increasingly enhanced in recent years, and according to such advances, cases in which a required performance cannot be obtained unless rubbers having low compatibility are combined are increasing.

In a method of improving the processability of a rubber by adding a processing aid such as an oil, since the processing aid may bleed to the outer circumferential surface of the roller main body after molding and cause contamination of the photoreceptor, application to a conductive roller is not possible.

Instead of use of a processing aid, a method of improving the processability of a rubber composition before crosslinking by adding a low-molecular weight liquid rubber which is a liquid at room temperature has been studied (refer to Patent Documents 1 and 2 and the like).

It is conceivable that, according to this method, since the liquid rubber is crosslinked to a rubber and incorporated into a crosslinked product, it is possible to minimize bleeding as occurring with a processing aid and contamination of the photoreceptor.

However, if an appropriate liquid rubber and its proportion are not selected for a rubber blend system, there are problems that:
sufficient improvement in the processability cannot be obtained, and
the liquid rubber cannot be favorably crosslinked, and a liquid rubber with a relatively low molecular weight bleeds to the outer circumferential surface of the roller main body and causes contamination of the photoreceptor in some cases.

[Patent Document 1] Japanese Patent Laid-Open No. 2007-291331

[Patent Document 2] Japanese Patent Laid-Open No. 2016-197217

The disclosure provides a rubber composition which is obtained by combining an appropriate liquid rubber with a blend system of rubbers having low compatibility that is compatible with advances in image forming devices and which has excellent processability and is unlikely to cause contamination and the like of a photoreceptor, has favorable characteristics as a rubber, and can form a roller main body of a conductive roller.

The disclosure also provides a conductive roller having a roller main body constituted by the rubber composition.

### SUMMARY

According to an embodiment of the disclosure, there is provided a rubber composition for forming a roller main body of a conductive roller, including rubbers including an epichlorohydrin rubber, emulsion-polymerized styrene butadiene rubber (E-SBR), and liquid polyisoprene rubber (LIR), and 3 parts by mass or more and 30 parts by mass or less of fillers with respect to 100 parts by mass of the total amount of the rubbers, wherein the proportion of the LIR is 3 parts by mass or more and 15 parts by mass or less with respect to 100 parts by mass of the total amount of the rubbers.

In addition, according to an embodiment of the disclosure, there is provided a conductive roller having a roller main body constituted by the rubber composition.

### BRIEF DESCRIPTION OF THE DRAWINGS

FIG. 1 is a perspective view showing an example of a conductive roller according to an embodiment of the disclosure.

### DESCRIPTION OF THE EMBODIMENTS

According to the disclosure, it is possible to provide a rubber composition which is obtained by combining an appropriate liquid rubber with a blend system of rubbers having low compatibility that is compatible with advances in image forming devices, and which has excellent processability and is unlikely to cause contamination and the like of a photoreceptor, has favorable characteristics as a rubber, and can form a roller main body of a conductive roller. In addition, according to the disclosure, it is possible to provide a conductive roller having a roller main body constituted by the rubber composition.

<<Rubber Composition>>

As described above, a rubber composition of the disclosure includes rubbers including an epichlorohydrin rubber, E-SBR, and LIR, and 3 parts by mass or more and 30 parts by mass or less of fillers with respect to 100 parts by mass of the total amount of the rubbers, in which the proportion of the LIR is 3 parts by mass or more and 15 parts by mass or less with respect to 100 parts by mass of the total amount of the rubbers.

When E-SBR is combined with an epichlorohydrin rubber, since the E-SBR has an effect of minimizing contamination of the photoreceptor as described above, it is expected to support advances in image forming devices.

However, since the above two types of rubbers have low compatibility and the proportion of fillers needs to be limited to being within the above range in order for the rubber to impart favorable characteristics to the roller main body, the processability of the rubber composition deteriorates and the various problems described above occur.

On the other hand, according to the disclosure, the above predetermined proportion of the LIR is additionally added to a blend system containing the above two types of rubbers and a small amount of fillers, and thereby it is possible to obtain a processability of the rubber composition which is improved with respect to the current situation while an effect of the blend system is maintained.

In addition, it is possible to form a roller main body of a conductive roller in which contamination of a photoreceptor and the like are unlikely to occur and in which a rubber has favorable characteristics.

This is also apparent from results of examples and comparative examples to be described below.

<Epichlorohydrin Rubber>

Examples of the epichlorohydrin rubber include an epichlorohydrin homopolymer, an epichlorohydrin-ethylene oxide binary copolymer (ECO), an epichlorohydrin-propylene oxide binary copolymer, an epichlorohydrin-allyl glycidyl ether binary copolymer, an epichlorohydrin-ethylene oxide-allyl glycidyl ether terpolymer (GECO), an epichlorohydrin-propylene oxide-allyl glycidyl ether terpolymer, and an epichlorohydrin-ethylene oxide-propylene oxide-allyl glycidyl ether quaternary copolymer.

Among these, a copolymer containing ethylene oxide, particularly, ECO and/or GECO is preferable.

Contents of ethylene oxide in ECO and/or GECO are both preferably 30 mol % or more, particularly 50 mol % or more, and preferably 80 mol % or less.

Ethylene oxide has an effect of lowering a roller resistance value of the conductive roller.

However, when the content of ethylene oxide is below the above range, such an effect may not be obtained sufficiently, and the roller resistance value of the conductive roller may not be sufficiently lowered.

On the other hand, when the content of ethylene oxide exceeds the above range, crystallization of ethylene oxide occurs, and segment movement of a molecular chain is inhibited, and thus a roller resistance value of the conductive roller tends to increase contrarily.

In addition, the roller main body after crosslinking may then become too hard, the viscosity of the rubber composition before crosslinking may increase during heating and melting, and the processability of the rubber composition may deteriorate in some cases.

A content of epichlorohydrin in ECO is the amount remaining after the ethylene oxide content.

That is, the content of epichlorohydrin is preferably 20 mol % or more, and preferably 70 mol % or less, and particularly 50 mol % or less.

In addition, a content of allyl glycidyl ether in GECO is preferably 0.5 mol % or more, particularly 2 mol % or more, and preferably 10 mol % or less, particularly 5 mol % or less.

Allyl glycidyl ether itself functions as a side chain to secure a free volume, and thereby minimizes crystallization of ethylene oxide, and thus has an effect of lowering a roller resistance value of the conductive roller.

However, when the content of allyl glycidyl ether is below the above range, since such an effect may not be obtained sufficiently, the roller resistance value of the conductive roller may not be sufficiently lowered.

On the other hand, allyl glycidyl ether functions as a crosslinking point when GECO is crosslinked.

Therefore, when the content of allyl glycidyl ether exceeds the above range, a crosslinking density of GECO becomes too high, and thus segment movement of a molecular chain is inhibited, and thereby the roller resistance value of the conductive roller tends to increase contrarily.

A content of epichlorohydrin in GECO is the amount remaining after the ethylene oxide content and the allyl glycidyl ether content.

That is, the content of epichlorohydrin is preferably 10 mol % or more, particularly 19.5 mol % or more, and preferably 69.5 mol % or less, particularly 60 mol % or less.

Here, regarding the GECO, in addition to the copolymer in which three types of monomers are copolymerized described above in a narrow sense, a modified component obtained by modifying an epichlorohydrin-ethylene oxide copolymer (ECO) with allyl glycidyl ether is known.

In the disclosure, any of such GECOs can be used.

One, two or more types of such epichlorohydrin rubbers can be used.

<E-SBR>

Regarding the E-SBR, any of various E-SBRs which are synthesized by copolymerizing styrene and 1,3-butadiene by an emulsion polymerization method and have a solid state at room temperature before crosslinking and have crosslinking properties can be used.

In addition, regarding the E-SBR, there are high styrene type, medium styrene type, and low styrene type E-SBRs classified according to a content of styrene, and any of them can be used.

In addition, regarding the E-SBR, there are an oil-extended type in which an extender oil is added to adjust the flexibility and a non-oil-extended type in which no extender oil is added. In the disclosure, in order to prevent contamination of the photoreceptor, E-SBR of a non-oil-extended type not containing an extender oil which may serve as a bleeding material is preferably used.

Regarding the non-oil-extended type E-SBR, for example, one, two or more types of the following various E-SBRs can be used.

JSR (registered trademark, commercially available from JSR) 1500 [amount of bonded styrene: 23.5%, Mooney viscosity ML₁₊₄ (100° C.): 52], JSR 1502 [amount of bonded styrene: 23.5%, Mooney viscosity ML₁₊₄ (100° C.): 52], JSR 1507 [amount of bonded styrene: 23.5%, Mooney viscosity ML₁₊₄ (100° C.): 35], JSR 0202 [amount of bonded styrene: 46%, Mooney viscosity ML₁₊₄ (100° C.): 45], and JSR 1503 [amount of bonded styrene: 23.5%, Mooney viscosity ML₁₊₄ (100° C.): 52].

Nipol (registered trademark, commercially available from Zeon Corporation) 1502 [amount of bonded styrene: 23.5%, Mooney viscosity ML₁₊₄ (100° C.):52].

<LIR>

Regarding the LIR, any of various LIRs which are a liquid at room temperature before crosslinking and have crosslinking properties can be used.

Particularly, an LIR having a number average molecular weight Mn of 28,000 or more and 58,000 or less is preferably used.

An LIR having a number average molecular weight Mn below this range has a very low viscosity, and it may be difficult to knead it into an epichlorohydrin rubber and an E-SBR.

Therefore, such an effect of improving the processability of the rubber composition by making LIR function as a processing aid may not be obtained sufficiently.

In addition, an amount of LIR remaining in the roller main body in a relatively low molecular weight state after crosslinking increases, and the LIR may bleed to the outer circumferential surface of the roller main body and cause contamination of the photoreceptor.

On the other hand, since LIR having a number average molecular weight Mn that exceeds the above range has a very large viscosity and is in a state that can hardly be called a liquid state at room temperature, such an effect of improving the processability of the rubber composition by making LIR function as a processing aid may not be obtained sufficiently.

On the other hand, when LIR having a number average molecular weight Mn that is in the above range is selected and used, it is possible to further improve the processability of the rubber composition while minimizing contamination of the photoreceptor due to bleeding.

Regarding the LIR having a number average molecular weight Mn that is inside the above range, for example, at least one of Kuraray (registered trademark, commercially available from Kuraray Co., Ltd.) LIR-30 [number average molecular weight Mn: 28,000], and LIR-50 [number average molecular weight Mn: 54,000] can be used.

<Other Rubbers>

Other rubbers may be additionally added to the rubber composition of the disclosure as long as effects obtained by combining the above three types of rubbers are not impaired.

Examples of other rubbers which may be added include ethylene propylene rubber.

When ethylene propylene rubber is added, it is possible to improve ozone resistance and weatherability of the roller main body.

Examples of ethylene propylene rubber include ethylene propylene rubber (EPM) which is a copolymer of ethylene and propylene and ethylene propylene diene rubber (EPDM) which is a copolymer of ethylene, propylene and diene. Particularly, EPDM is preferable.

Regarding the EPDM, various copolymers obtained by copolymerizing ethylene, propylene, and a diene can be used.

Examples of a diene include ethylidene norbornene (ENB) and dicyclopentadiene (DCPD).

In addition, as EPDM, there are an oil-extended type in which an extender oil is added to adjust the flexibility and a non-oil-extended type in which no extender oil is added. In the disclosure, in order to prevent contamination of the photoreceptor and the like, non-oil-extended type EPDM not containing an extender oil which may serve as a bleeding material is preferably used.

One, two, or more types of such EPDMs can be used.

<Proportions of Rubbers>

(LIR)

The proportion of the LIR is limited to 3 parts by mass or more and 15 parts by mass or less with respect to 100 parts by mass of the total amount of the rubbers. The reason for this is as follows.

That is, when the proportion of the LIR is below the above range, an effect of improving the processability of the rubber composition resulting from addition of the LIR is not obtained.

Even if the proportion of the LIR is below the above range, when a large amount of fillers exceeding 30 parts by mass is added, the processability can be improved. However, in this case, the flexibility of the roller main body deteriorates, favorable characteristics as a rubber are not obtained, and a compression set of the roller main body increases.

In addition, when a compression set increases, a part of the roller main body in contact with the photoreceptor is likely to partially deform in some cases.

On the other hand, when the proportion of the LIR exceeds the above range, an amount of LIR remaining in the roller main body in a relatively low molecular weight state after crosslinking increases, and the LIR bleeds to the outer circumferential surface of the roller main body and causes contamination of the photoreceptor.

In addition, when a compression set of the roller main body increases, a part of the roller main body in contact with the photoreceptor is likely to partially deform in some cases.

On the other hand, when the proportion of the LIR is set to be within the above range, it is possible to further improve the processability of the rubber composition while minimizing contamination of the photoreceptor due to bleeding and deformation of the roller main body.

Here, in order to further improve such effects, the proportion of the LIR is preferably 5 parts by mass or more and preferably 10 parts by mass or less within the above range with respect to 100 parts by mass of the total amount of the rubbers.

The proportion of the LIR is a proportion of the LIR when only one type is used as the LIR, and is a proportion of a total thereof when two or more types of LIRs are used in combination.

(Epichlorohydrin Rubber, E-SBR)

The proportion of the epichlorohydrin rubber is preferably 50 parts by mass or more, particularly 60 parts by mass or more, and preferably 80 parts by mass or less, particularly 70 parts by mass or less with respect to 100 parts by mass of the total amount of the rubbers.

The proportion of E-SBR is the amount remaining after the LIR and epichlorohydrin rubber.

That is, the proportion of E-SBR may be set so that a total amount of rubber is 100 parts by mass when the proportions of LIR and an epichlorohydrin rubber are set to have predetermined values within the above ranges.

When the proportion of the epichlorohydrin rubber is below the above range or exceeds the above range, in either of these cases, the roller resistance value of the conductive roller may not be adjusted to be within a range suitable for use in an arbitrary process when incorporated into an image forming device.

In addition, when the relative proportion of E-SBR decreases, favorable characteristics as a rubber may not be imparted to the roller main body.

On the other hand, when the proportion of the epichlorohydrin rubber is set to be within the above range, the roller resistance value of the conductive roller can be adjusted to be within a range suitable for use in an arbitrary process when incorporated into an image forming device.

In addition, favorable characteristics as a rubber can be imparted to the roller main body.

Also, the proportion of the epichlorohydrin rubber is a proportion of the epichlorohydrin rubber when only one type is used as the epichlorohydrin rubber, and is a proportion of a total thereof when two or more types of epichlorohydrin rubbers are used in combination.

Similarly, the proportion of E-SBR is a proportion of ESBR when only one type is used as the E-SBR, and is a proportion of a total thereof when two or more types of E-SBRs are used in combination.

(EPDM)

When EPDM is added as the other rubber, the proportion is preferably 3 parts by mass or more and preferably 12 parts by mass or less with respect to 100 parts by mass of the total amount of the rubbers.

When the proportion of EPDM is below the above range, the EPDM is added and such an effect of improving ozone resistance and weatherability of the roller main body may not be obtained sufficiently.

On the other hand, when the proportion of EPDM exceeds the above range, the proportion of the epichlorohydrin rubber, E-SBR, or LIR is relatively low, and when these rubbers are used in combination, the above-described various effects may not be obtained.

On the other hand, when the proportion of EPDM is set to be within the above range, it is possible to improve ozone resistance and weatherability of the roller main body while maintaining various effects by using an epichlorohydrin rubber, E-SBR, and LIR in combination.

Also, the proportion of EPDM is a proportion of EPDM when only one type is used as the EPDM, and is a proportion of a total thereof when two or more types of EPDMs are used in combination.

<Filler>

Regarding the filler, for example, one, two, or more types of the followings can be used.
Carbon black, calcium carbonate, silica, clay, talc, magnesium carbonate, aluminum hydroxide, titanium oxide, and the like which function as a reinforcing agent, a filling agent, or the like,
Zinc oxide which functions as a crosslinking promoting aid of rubber, and
Hydrotalcites and the like functioning as an acid acceptor which prevents a chlorine-based gas generated from an epichlorohydrin rubber and the like during crosslinking from remaining in the roller main body, thereby preventing crosslinking inhibition and contamination and the like of the photoreceptor.

Particularly, regarding the filler, it is preferable to use at least two types including zinc oxide and a hydrotalcite in combination, and more preferable to use three types including carbon black in combination.

Among these, regarding the hydrotalcites, those in which the hydrotalcites are used together with magnesium oxide or potassium oxide can be used.

In addition, conductive carbon black can be used as carbon black.

When conductive carbon black is used, electron conductivity can be imparted to the roller main body.

Regarding the conductive carbon black, for example, acetylene black and the like may be used.

The proportion (total amount) of fillers including at least two or three types thereof is limited to 3 parts by mass or more and 30 parts by mass or less with respect to 100 parts by mass of the total amount of the rubbers. The reason for this is as follows.

That is, when a total amount of fillers contributing to kneading of the rubbers is below the above range, the processability of the rubber composition deteriorates.

In addition, various functions resulting from addition of such fillers become insufficient.

Specifically, a function as a crosslinking promoting aid according to zinc oxide, a function as an acid acceptor according to hydrotalcites, a function as a reinforcing agent according to carbon black, and a function of imparting electron conductivity according to conductive carbon black may not be obtained sufficiently.

On the other hand, when a total amount of fillers exceeds the above range, the flexibility of the roller main body deteriorates, and members such as a developing blade or a seal part of a cartridge are likely to become worn.

In addition, it is not possible to sufficiently secure an appropriate nip width during contact with the photoreceptor and the like.

In addition, when a compression set of the roller main body increases, a part of the roller main body in contact with the photoreceptor is likely to partially deform in some cases.

On the other hand, when a total amount of fillers is set to be within the above range, functions of respective fillers can be favorably exhibited while preventing the flexibility of the roller main body from deteriorating and a compression set from increasing.

Here, in order to further improve such effects, the total amount of fillers is preferably 8 parts by mass or more within the above range with respect to 100 parts by mass of the total amount of the rubbers.

In addition, the total proportion of two types of fillers of zinc oxide and hydrotalcites among fillers is preferably 3 parts by mass or more and preferably 15 parts by mass or less with respect to 100 parts by mass of the total amount of the rubbers.

When the total proportion of two types of fillers is below the above range, a function as a crosslinking promoting aid according to zinc oxide and a function as an acid acceptor according to hydrotalcites may not be obtained sufficiently.

On the other hand, when the total proportion of two types of fillers exceeds the above range, for example, in a system using carbon black in combination, the proportion of the carbon black decreases, and a function as a reinforcing agent according to carbon black may not be obtained sufficiently.

On the other hand, when the total proportion of two types of fillers of zinc oxide and hydrotalcites is set to be within the above range, functions of respective fillers can be favorably exhibited.

Here, in order to further improve such effects, the total proportion of two types of fillers of zinc oxide and hydrotalcites is preferably 6 parts by mass or more and preferably 10 parts by mass or less within the above range with respect to 100 parts by mass of the total amount of the rubbers.

<Crosslinking Component>

A crosslinking component is added to the rubber composition in the same manner as in the related art.

Regarding the crosslinking component, a crosslinking agent for crosslinking rubber and a crosslinking promoter for promoting crosslinking of rubber using the crosslinking agent are preferably used in combination.

Among these, regarding the crosslinking agent, for example, a sulfur-based crosslinking agent, a thiourea-based crosslinking agent, a triazine derivative-based crosslinking agent, a peroxide-based crosslinking agent, various monomers, and the like may be used. Particularly, a sulfur-based crosslinking agent is preferable.

(Sulfur-Based Crosslinking Agent)

Examples of the sulfur-based crosslinking agent include sulfurs such as sulfur powder, oil-treated sulfur powder, precipitated sulfur, colloidal sulfur, and dispersible sulfur and an organic-sulfur-containing compound such as tetramethylthiuram disulfide and N,N-dithiobismorpholine. Particularly, sulfur is preferable.

In order for the rubber to impart favorable characteristics to the roller main body, the proportion of sulfur is preferably 0.5 parts by mass or more and preferably 2 parts by mass or less with respect to 100 parts by mass of the total amount of the rubbers.

Here, for example, when oil-treated sulfur powder, dispersible sulfur, or the like is used as sulfur, the proportion is a proportion of sulfur itself as an active component contained therein.

In addition, when an organic-sulfur-containing compound is used as the crosslinking agent, the proportion is preferably adjusted so that the proportion of sulfur contained in molecules with respect to 100 parts by mass of the total amount of the rubbers is within the above range.

(Crosslinking Promoter)

Examples of the crosslinking promoter for promoting crosslinking of rubbers include one, two, or more types of a thiuram-based promoter, a thiazole-based promoter, a thiourea-based promoter, a guanidine-based promoter, a sulfenamide-based promoter, and a dithiocarbamate-based promoter.

Among these, it is preferable to use a thiuram-based promoter, a thiazole-based promoter, a thiourea-based promoter, and a guanidine-based promoter in combination.

Examples of the thiuram-based promoter include one, two, or more types of tetramethylthiuram monosulfide, tetramethylthiuram disulfide, tetraethylthiuram disulfide, tetrabutylthiuram disulfide, and dipentamethylene thiuram tetrasulfide. Particularly, tetramethylthiuram monosulfide is preferable.

Examples of the thiazole-based promoter include one, two, or more types of 2-mercaptobenzothiazole, di-2-benzothiazolyl disulfide, a zinc salt of 2-mercaptobenzothiazole, a cyclohexylamine salt of 2-mercaptobenzothiazole, and 2-(4′-morpholinodithio)benzothiazole. Particularly, di-2-benzothiazolyl disulfide is preferable.

Regarding the thiourea-based promoter, various thiourea compounds having a thiourea structure in the molecule can be used.

Examples of the thiourea-based promoter include one, two, or more types of ethylene thiourea, N,N′-diphenylthiourea, trimethylthiourea, a thiourea represented by Formula (1):

(CnH₂n+1NH)₂C═S (1)

[where, n is an integer of 1 to 12], tetramethylthiourea, and the like. Particularly, ethylene thiourea is preferable.

Examples of the guanidine-based promoter include one, two, or more types of 1,3-diphenylguanidine, 1,3-di-o-tolylguanidine, 1-o-tolyl biguanide, and the like. Particularly, 1,3-di-o-tolylguanidine is preferable.

In a system using the above four types in combination, in order to exhibit such an effect of promoting crosslinking of rubber sufficiently, the proportion of the thiuram-based promoter is preferably 0.3 parts by mass or more and 1 part by mass or less with respect to 100 parts by mass of the total amount of the rubbers.

In addition, the proportion of the thiazole-based promoter is preferably 0.3 parts by mass or more and 2 parts by mass or less with respect to 100 parts by mass of the total amount of the rubbers.

The proportion of the thiourea-based promoter is preferably 0.3 parts by mass or more and 1 part by mass or less with respect to 100 parts by mass of the total amount of the rubbers.

In addition, the proportion of the guanidine-based promoter is preferably 0.2 parts by mass or more and 1 part by mass or less with respect to 100 parts by mass of the total amount of the rubbers.

The thiourea-based promoter functions as a crosslinking agent of ECO having no sulfur crosslinking properties, and the guanidine-based promoter functions as a promoter for crosslinking ECO according to the thiourea-based promoter.

<Others>

Various additives may be additionally added to the rubber composition as necessary.

Regarding the additive, various additives, for example, a deterioration inhibitor, a scorching inhibitor, a plasticizer, a lubricant, a pigment, an antistatic agent, a flame retardant, a neutralizing agent, a nucleating agent, and a co-crosslinking agent can be added in an arbitrary proportion.

<<Conductive Roller>>

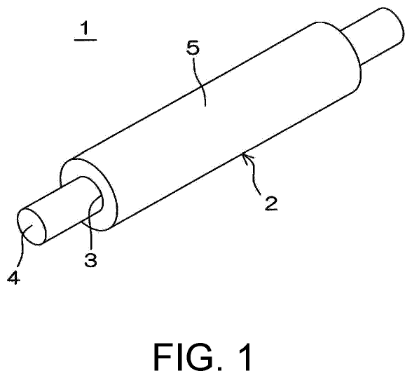

FIG. 1 is a perspective view showing an example of a conductive roller according to an embodiment of the disclosure.

Referring to FIG. 1, a conductive roller 1 of this example includes a roller main body 2 formed into a nonporous and single-layer cylindrical shape constituted by the rubber composition containing the above components. A shaft 4 is inserted into and fixed to a through-hole 3 at the center of the roller main body 2.

The shaft 4 is integrally formed of a highly conductive material, for example, a metal such as iron, aluminum, an aluminum alloy, or stainless steel.

For example, the shaft 4 is electrically connected and mechanically fixed to the roller main body 2 using an adhesive having conductivity, or when a shaft having an outer diameter larger than the inner diameter of the through-hole 3 is press-fitted into the through-hole 3, it is electrically connected and mechanically fixed to the roller main body 2.

In addition, using both methods together, the shaft 4 may be electrically connected and mechanically fixed to the roller main body 2.

The roller resistance value R(Ω) of the conductive roller 1 can be set to be within a range suitable for its application according to the application of the conductive roller.

<Production of Conductive Roller>

In order to produce the conductive roller 1 of the disclosure, first, the rubber composition containing the above-described components is extruded and molded into a cylindrical shape using an extrusion molding machine, then cut to a predetermined length, and pressurized with pressurized steam in a vulcanizer, heated and crosslinked.

Next, the crosslinked cylindrical component is heated using an oven or the like and subjected to secondary crosslinking and then cooled, and additionally polished so that it has a predetermined outer diameter, and thereby the roller main body 2 is formed.

The shaft 4 can be inserted into and fixed to the through-hole 3 at any time from after the cylindrical component is cut until after polishing.

However, after cutting, it is preferable to perform secondary crosslinking and polishing first while the shaft 4 is inserted into the through-hole 3.

Therefore, it is possible to minimize warping, deformation, and the like of the cylindrical component due to expansion and contraction during secondary crosslinking.

In addition, when polishing is performed while rotating around the shaft 4, it is possible to improve workability of the polishing and minimize deflection of an outer circumferential surface 5.

As described above, the shaft 4 is inserted into the through-hole 3 of the cylindrical component before secondary crosslinking using an adhesive having conductivity, and particularly, a conductive thermosetting adhesive, and then subjected to secondary crosslinking, or a shaft having an outer diameter larger than the inner diameter of the through-hole 3 may be press-fitted into the through-hole 3.

In the former case, a cylindrical component is subjected to secondary crosslinking due to heating in an oven and, and at the same time, a thermosetting adhesive is cured, and the shaft 4 is electrically connected and mechanically fixed to the roller main body 2.

In addition, in the latter case, press-fitting is performed, and at the same time, electrical connection and mechanical fixing are completed.

In addition, as described above, using both methods together, the shaft 4 may be electrically connected and mechanically fixed to the roller main body 2.

For example, in image forming devices using electrophotography such as a laser printer, an electrostatic copying machine, a plain paper facsimile machine, and a multifunctional machine thereof, the conductive roller 1 of the disclosure can be used as, for example, a charging roller, a developing roller, a transfer roller, and a cleaning roller.

### EXAMPLES

The disclosure will be described below in detail based on examples, comparative examples, and conventional examples. However, the configuration of the disclosure is not necessarily limited to these examples and comparative examples.

### Example 1

(Rubber Composition)

Regarding the rubber, 65 parts by mass of GECO [Epichromer (registered trademark) CG-102 commercially available from Osaka Soda Co., Ltd.], 27.5 parts by mass of E-SBR [Nipol 1502 commercially available from Zeon Corporation, amount of bonded styrene: 23.5%, Mooney viscosity ML₁₊₄ (100° C.): 52], and 7.5 parts by mass of LIR [Kuraray LIR-50 commercially available from Kuraray Co., Ltd., number average molecular weight Mn: 54,000] were added.

Then, while masticating 100 parts by mass of the total amount of the rubbers using a kneader, first the following three types of fillers were added and kneaded.

TABLE 1

| Filler | Parts by mass |
|---|---|
| Conductive carbon black | 2 |
| Zinc oxide | 3 |
| Hydrotalcites | 3 |

Components in Table 1 are as follows. Here, the term “parts by mass” in Table 1 indicates parts by mass with respect to 100 parts by mass of the total amount of the rubbers.

Conductive carbon black: reinforcing agent [Denka Black (registered trademark) commercially available from Denka Co., Ltd., acetylene black, granular form]

Zinc oxide: crosslinking promoting aid [two types of zinc oxide commercially available from Mitsui Mining & Smelting Co., Ltd.]

Hydrotalcites: acid acceptor [DHT-4A (registered trademark)-2 commercially available from Kyowa Chemical Industry Co., Ltd.]

The total amount of three types of fillers with respect to 100 parts by mass of the total amount of the rubbers was 8 parts by mass, and the total proportion of two types including zinc oxide and a hydrotalcite was 6 parts by mass.

Next, the following crosslinking components were added, and kneading was additionally performed using a roll mill to prepare a rubber composition.

TABLE 2

| Crosslinking component | Parts by mass |
|---|---|
| Sulfur | 1.05 |
| Promoter TS | 0.5 |
| Promoter DM | 1.5 |
| Promoter 22 | 0.33 |
| Promoter DT | 0.28 |

Components in Table 2 are as follows. In addition, the parts by mass in the table are parts by mass with respect to 100 parts by mass of the total amount of the rubbers.

Sulfur: crosslinking agent [sulfur with 5% oil, commercially available from Tsurumi Chemical Industry Co., Ltd.]

Promoter TS: tetramethylthiuram monosulfide [Sanceler (registered trademark, commercially available from Sanshin Chemical Industry Co., Ltd.) TS, thiuram-based promoter]

Promoter DM: di-2-benzothiazolyl disulfide [product name SUNSINE MBTS commercially available from Shandong Shanxian Chemical Co., Ltd.]

Promoter 22: ethylene thiourea [Accelerator (registered trademark, commercially available from Kawaguchi Chemical Industry Co., Ltd.) 22-S, 2-mercaptoimidazoline] Promoter DT: 1,3-di-o-tolylguanidine [Sanceler DT (commercially available from Sanshin Chemical Industry Co., Ltd.), guanidine-based promoter]

(Conductive Roller)

The prepared rubber composition was supplied to an extrusion molding machine and extruded and molded into a cylindrical shape with an outer diameter of φ 14 mm and an inner diameter of φ 5 mm, and then cut to a predetermined length, and pressurized and heated in a vulcanizer with pressurized steam at 145° C. for 180 minutes to crosslink rubber.

Next, the crosslinked cylindrical component was attached to the shaft 4 having an outer circumferential surface to which a conductive thermosetting adhesive was applied and having an outer diameter of φ 6 mm was subjected to secondary crosslinking in an oven, and electrically connected and mechanically fixed to the shaft 4 by curing the thermosetting adhesive.

Then, both ends of the cylindrical component was shaped, the outer circumferential surface 5 was then subjected to traverse grinding using a cylindrical grinding machine, the roller main body 2 was formed, and thereby a conductive roller 1 was produced.

### Example 2

A rubber composition was prepared in the same manner as in Example 1 except that an amount of E-SBR was 20 parts by mass, and an amount of LIR was 15 parts by mass to produce a conductive roller 1.

The total amount of three types of fillers with respect to 100 parts by mass of the total amount of the rubbers was 8 parts by mass, and the total proportion of two types including zinc oxide and a hydrotalcite was 6 parts by mass.

### Example 3

A rubber composition was prepared in the same manner as in Example 1 except that an amount of E-SBR was 32 parts by mass, and an amount of LIR was 3 parts by mass to produce a conductive roller 1.

The total amount of three types of fillers with respect to 100 parts by mass of the total amount of the rubbers was 8 parts by mass, and the total proportion of two types including zinc oxide and a hydrotalcite was 6 parts by mass.

### Examples 4 to 6

Rubber compositions were prepared in the same manner as in Examples 1 to 3 except that an amount of carbon black was 20 parts by mass, an amount of zinc oxide was 5 parts by mass, and an amount of hydrotalcites was 5 parts by mass to produce conductive rollers 1.

The total amount of three types of fillers with respect to 100 parts by mass of the total amount of the rubbers was 30 parts by mass, and the total proportion of two types including zinc oxide and a hydrotalcite was 10 parts by mass.

### Example 7

A rubber composition was prepared in the same manner as in Example 1 except that an amount of E-SBR was 17.5 parts by mass, and additionally 10 parts by mass of EPDM [Esprene (registered trademark) 301 commercially available from Sumitomo Chemical Co., Ltd.] was added, and an amount of hydrotalcites was 4 parts by mass to produce a conductive roller 1.

The total amount of three types of fillers with respect to 100 parts by mass of the total amount of the rubbers was 9 parts by mass, and the total proportion of two types including zinc oxide and a hydrotalcite was 7 parts by mass.

### Examples 8 to 11

Rubber compositions were prepared in the same manner as in Examples 1 to 4 except that, as LIR, the same amount of Kuraray LIR-30 (commercially available from Kuraray Co., Ltd.) having a number average molecular weight Mn of 28,000 was added to produce conductive rollers 1.

In Examples 8 to 10, the total amount of three types of fillers with respect to 100 parts by mass of the total amount of the rubbers was 8 parts by mass, and the total proportion of two types including zinc oxide and a hydrotalcite was 6 parts by mass.

In addition, in Example 11, the total amount of three types of fillers with respect to 100 parts by mass of the total amount of the rubbers was 30 parts by mass, and the total proportion of two types including zinc oxide and a hydrotalcite was 10 parts by mass.

### Example 12

A rubber composition was prepared in the same manner as in Example 1 except that, in place of GECO, the same amount ECO [HYDRIN (registered trademark) H1100 commercially available from Zeon Corporation] was added to produce a conductive roller 1.

The total amount of three types of fillers with respect to 100 parts by mass of the total amount of the rubbers was 8 parts by mass, and the total proportion of two types including zinc oxide and a hydrotalcite was 6 parts by mass.

### Example 13

A rubber composition was prepared in the same manner as in Example 1 except that an amount of GECO was 32.5 parts by mass, and additionally 32.5 parts by mass of ECO [HYDRIN (registered trademark) H1100 commercially available from Zeon Corporation] was added to produce a conductive roller 1.

The total amount of three types of fillers with respect to 100 parts by mass of the total amount of the rubbers was 8 parts by mass, and the total proportion of two types including zinc oxide and a hydrotalcite was 6 parts by mass.

### Comparative Examples 1 and 2

Rubber compositions were prepared in the same manner as in Examples 1 and 4 except that an amount of E-SBR was 35 parts by mass, and no LIR was added to produce conductive rollers 1.

In Comparative Example 1, the total amount of three types of fillers with respect to 100 parts by mass of the total amount of the rubbers was 8 parts by mass, and the total proportion of two types including zinc oxide and a hydrotalcite was 6 parts by mass.

In addition, in Comparative Example 2, the total amount of three types of fillers with respect to 100 parts by mass of the total amount of the rubbers was 30 parts by mass, and the total proportion of two types including zinc oxide and a hydrotalcite was 10 parts by mass.

### Comparative Example 3

A rubber composition was prepared in the same manner as in Comparative Example 2 except that an amount of carbon black was 30 parts by mass to produce a conductive roller 1.

The total amount of three types of fillers with respect to 100 parts by mass of the total amount of the rubbers was 40 parts by mass, and the total proportion of two types including zinc oxide and a hydrotalcite was 10 parts by mass.

### Comparative Example 4

A rubber composition was prepared in the same manner as in Comparative Example 1 except that an amount of E-SBR was 25 parts by mass, and additionally 10 parts by mass of EPDM [Esprene (registered trademark) 301 commercially available from Sumitomo Chemical Co., Ltd.] was added, and an amount of hydrotalcites was 4 parts by mass to produce a conductive roller 1.

The total amount of three types of fillers with respect to 100 parts by mass of the total amount of the rubbers was 9 parts by mass, and the total proportion of two types including zinc oxide and a hydrotalcite was 7 parts by mass.

### Comparative Example 5

A rubber composition was prepared in the same manner as in Example 1 except that an amount of E-SBR was 34 parts by mass, and an amount of LIR was 1 part by mass to produce a conductive roller 1.

The total amount of three types of fillers with respect to 100 parts by mass of the total amount of the rubbers was 8 parts by mass, and the total proportion of two types including zinc oxide and a hydrotalcite was 6 parts by mass.

### Comparative Example 6

A rubber composition was prepared in the same manner as in Example 1 except that an amount of E-SBR was 15 parts by mass, and an amount of LIR was 20 parts by mass to produce a conductive roller 1.

The total amount of three types of fillers with respect to 100 parts by mass of the total amount of the rubbers was 8 parts by mass, and the total proportion of two types including zinc oxide and a hydrotalcite was 6 parts by mass.

### Comparative Example 7

A rubber composition was prepared in the same manner as in Example 8 except that an amount of E-SBR was 34 parts by mass, and an amount of LIR was 1 part by mass to produce a conductive roller 1.

The total amount of three types of fillers with respect to 100 parts by mass of the total amount of the rubbers was 8 parts by mass, and the total proportion of two types including zinc oxide and a hydrotalcite was 6 parts by mass.

### Comparative Example 8

A rubber composition was prepared in the same manner as in Example 8 except that an amount of E-SBR was 15 parts by mass, and an amount of LIR was 20 parts by mass to produce a conductive roller 1.

The total amount of three types of fillers with respect to 100 parts by mass of the total amount of the rubbers was 8 parts by mass, and the total proportion of two types including zinc oxide and a hydrotalcite was 6 parts by mass.

### Comparative Example 9

A rubber composition was prepared in the same manner as in Example 1 except that, in place of LIR, the same amount of liquid polybutadiene rubber having a number average molecular weight Mn of 26,000 [LBR, Kuraray LBR-305 commercially available from Kuraray Co., Ltd.] was added to produce a conductive roller 1.

The total amount of three types of fillers with respect to 100 parts by mass of the total amount of the rubbers was 8 parts by mass, and the total proportion of two types including zinc oxide and a hydrotalcite was 6 parts by mass.

### Comparative Example 10

A rubber composition was prepared in the same manner as in Example 1 except that, in place of LIR, the same amount of LBR having a number average molecular weight Mn of 8,000 [Kuraray LBR-307 commercially available from Kuraray Co., Ltd.] was added to produce a conductive roller 1.

The total amount of three types of fillers with respect to 100 parts by mass of the total amount of the rubbers was 8 parts by mass, and the total proportion of two types including zinc oxide and a hydrotalcite was 6 parts by mass.

### Comparative Example 11

A rubber composition was prepared in the same manner as in Example 1 except that, in place of LIR, the same amount of liquid styrene butadiene rubber having a number average molecular weight Mn of 8,500 [LSBR, Kuraray L-SBR-820 commercially available from Kuraray Co., Ltd.] was added to produce a conductive roller 1.

The total amount of three types of fillers with respect to 100 parts by mass of the total amount of the rubbers was 8 parts by mass, and the total proportion of two types including zinc oxide and a hydrotalcite was 6 parts by mass.

<Evaluation of Processability>

(Workability of Kneading)

In the examples and comparative examples, states in which components were kneaded using a roll mill to prepare a rubber composition were observed, and workability of kneading was evaluated according to the following criteria.

∘: Rubber was smoothly wound around the roller and smoothly kneaded in a short time.
Δ: Although winding of rubber around the roller was slightly poor, the work itself was able to proceed substantially in the same manner as in “∘.”
x: Rubber was not smoothly wound around the roller, and kneading took time.

(Extrusion Moldability)

The extruded surfaces of the cylindrical components produced by extruding and molding the rubber compositions prepared in the examples and comparative examples, that is, the outer circumferential surfaces of the cylindrical components before polishing and the inner circumferential surfaces of the through-holes after extrusion and molding, were observed, and extrusion moldability was evaluated according to the following criteria.

∘: No irregularities were observed on the extruded surface.
Δ: Although some irregularities were observed on the extruded surface, there were not to an extent that interfered with practical use.
x: Severe irregularities were observed on the extruded surface.

<Actual Machine Test>

In place of a genuine charging roller of a new cartridge which includes a toner container, a photoreceptor, a charging roller in contact with the photoreceptor, and a developing roller and is detachable from a laser printer, the conductive rollers produced in the examples and the comparative examples were incorporated.

Next, a toner cartridge into which the conductive roller was incorporated was left under an environment with a temperature of 50° C. and a relative humidity of 90% for 2 weeks, and then loaded in the laser printer to form an image.

Then, the formed images were observed, and the formed images were evaluated based on the presence of the following two types of image defects.

(Contamination of Photoreceptor)

Image defects occurring when an area of the outer circumferential surface of the photoreceptor with which the roller main body of the charging roller was in contact was contaminated due to the component bleeding to the outer circumferential surface of the roller main body when left alone were observed.

The image defects occurred on the formed image in the rotation period of the photoreceptor.

### ∘: None.

Δ: Although it appeared very thin, it was not to an extent that interfered with practical use.

### x: Yes

(Deformation)

Image defects occurring when an area of the outer circumferential surface of the roller main body of the charging roller with which the photoreceptor was in contact was partially deformed when left alone were observed.

The image defects occurred on the formed image in the rotation period of the charging roller.

### ∘: None.

Δ: Although it appeared very thin, it was not to an extent that interfered with practical use.

### x: Yes.

The above results are shown in Table 3 to Table 6. Here, in the table, in the column of the number average molecular weight Mn, when the number average molecular weight Mn is, for example, 54,000, it is described as 54 K or the like.

TABLE 3

| | | | Example 1 | Example 2 | Example 3 | Example 4 | Example 5 | Example 6 | Example 7 |
|---|---|---|---|---|---|---|---|---|---|
| Parts by | GECO | | 65 | 65 | 65 | 65 | 65 | 65 | 65 |
| mass | ECO | | — | — | — | — | — | — | — |
| | E-SBR | | 27.5 | 20 | 32 | 27.5 | 20 | 32 | 17.5 |
| | EPDM | | — | — | — | — | — | — | 10 |
| | LIR | Mn: 54K | 7.5 | 15 | 3 | 7.5 | 15 | 3 | 7.5 |
| | | Mn: 28K | — | — | — | — | — | — | — |
| | LBR | Mn: 26K | — | — | — | — | — | — | — |
| | | Mn: 8k | — | — | — | — | — | — | — |
| | LSBR | Mn: 8.5K | — | — | — | — | — | — | — |

| | | | | | | | | |
|---|---|---|---|---|---|---|---|---|
| | Conductive carbon | 2 | 2 | 2 | 20 | 20 | 20 | 2 |
| | black | | | | | | | |
| | Zinc oxide | 3 | 3 | 3 | 5 | 5 | 5 | 3 |
| | Hydrotalcites | 3 | 3 | 3 | 5 | 5 | 5 | 4 |
| Evaluation | Workability of | ◯ | ◯ | ◯ | ◯ | ◯ | ◯ | ◯ |
| | kneading | | | | | | | |
| | Extrusion | ◯ | ◯ | Δ | ◯ | ◯ | ◯ | ◯ |
| | moldability | | | | | | | |
| | Contamination of | ◯ | Δ | ◯ | ◯ | Δ | ◯ | ◯ |
| | photoreceptor | | | | | | | |
| | Deformation | ◯ | ◯ | ◯ | Δ | Δ | Δ | ◯ |

TABLE 4

| | | | Example 8 | Example 9 | Example 10 | Example 11 | Example 12 | Example 13 |
|---|---|---|---|---|---|---|---|---|
| Parts by | GECO | | 65 | 65 | 65 | 65 | — | 32.5 |
| mass | ECO | | — | — | — | — | 65 | 32.5 |
| | E-SBR | | 27.5 | 20 | 32 | 27.5 | 27.5 | 27.5 |
| | EPDM | | — | — | — | — | — | — |
| | LIR | Mn: 54K | — | — | — | — | 7.5 | 7.5 |
| | | Mn: 28K | 7.5 | 15 | 3 | 7.5 | — | — |
| | LBR | Mn: 26K | — | — | — | — | — | — |
| | | Mn: 8k | — | — | — | — | — | — |
| | LSBR | Mn: 8.5K | — | — | — | — | — | — |

| | | | | | | | |
|---|---|---|---|---|---|---|---|
| | Conductive carbon | 2 | 2 | 2 | 20 | 2 | 2 |
| | black | | | | | | |
| | Zinc oxide | 3 | 3 | 3 | 5 | 3 | 3 |
| | Hydrotalcites | 3 | 3 | 3 | 5 | 3 | 3 |
| Evaluation | Workability of | ◯ | ◯ | ◯ | ◯ | ◯ | ◯ |
| | kneading | | | | | | |
| | Extrusion | ◯ | ◯ | Δ | ◯ | ◯ | ◯ |
| | moldability | | | | | | |
| | Contamination of | ◯ | Δ | ◯ | Δ | ◯ | ◯ |
| | photoreceptor | | | | | | |
| | Deformation | ◯ | ◯ | ◯ | Δ | ◯ | ◯ |

TABLE 5

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Parts by | GECO | | 65 | 65 | 65 | 65 | 65 | 65 |
| mass | ECO | | — | — | — | — | — | — |
| | E-SBR | | 35 | 35 | 35 | 25 | 34 | 15 |
| | EPDM | | — | — | — | 10 | — | — |
| | LIR | Mn: 54K | — | — | — | — | 1 | 20 |
| | | Mn: 28K | — | — | — | — | — | — |
| | LBR | Mn: 26K | — | — | — | — | — | — |
| | | Mn: 8k | — | — | — | — | — | — |
| | LSBR | Mn: 8.5K | — | — | — | — | — | — |

| | | | | | | | |
|---|---|---|---|---|---|---|---|
| | Conductive carbon | 2 | 20 | 30 | 2 | 2 | 2 |
| | black | | | | | | |
| | Zinc oxide | 3 | 5 | 5 | 3 | 3 | 3 |
| | Hydrotalcites | 3 | 5 | 5 | 4 | 3 | 3 |
| Evaluation | Workability of | X | Δ | ◯ | X | Δ | ◯ |
| | kneading | | | | | | |
| | Extrusion | X | X | ◯ | X | X | ◯ |
| | moldability | | | | | | |
| | Contamination of | ◯ | ◯ | ◯ | ◯ | ◯ | X |
| | photoreceptor | | | | | | |
| | Deformation | ◯ | Δ | X | ◯ | ◯ | Δ |

TABLE 6

| | | | Comparative | Comparative | Comparative | Comparative | Comparative |
|---|---|---|---|---|---|---|---|
| | | | Example 7 | Example 8 | Example 9 | Example 10 | Example 11 |
| Parts by | GECO | | 65 | 65 | 65 | 65 | 65 |
| mass | ECO | | — | — | — | — | — |
| | E-SBR | | 34 | 15 | 27.5 | 27.5 | 27.5 |
| | EPDM | | — | — | — | — | — |
| | LIR | Mn: 54K | — | — | — | — | — |
| | | Mn: 28K | 1 | 20 | — | — | — |
| | LBR | Mn: 26K | — | — | 7.5 | — | — |
| | | Mn: 8k | — | — | — | 7.5 | — |
| | LSBR | Mn: 8.5K | — | — | — | — | 7.5 |

| | | | | | | |
|---|---|---|---|---|---|---|
| | Conductive carbon | 2 | 2 | 2 | 2 | 2 |
| | black | | | | | |
| | Zinc oxide | 3 | 3 | 3 | 3 | 3 |
| | Hydrotalcites | 3 | 3 | 3 | 3 | 3 |
| Evaluation | Workability of | Δ | ◯ | ◯ | ◯ | ◯ |
| | kneading | | | | | |
| | Extrusion | X | ◯ | X | X | X |
| | moldability | | | | | |
| | Contamination of | ◯ | X | X | X | X |
| | photoreceptor | | | | | |
| | Deformation | ◯ | Δ | Δ | Δ | Δ |

Based on the results of Examples 1 to 13, Comparative Examples 1 to 4, and Comparative Examples 9 to 11 in Table 3 to Table 6, it was found that, when LIR as liquid rubber was added to a system in which an epichlorohydrin rubber and E-SBR were used in combination, it was possible to improve the processability of the rubber composition, contamination and the like of the photoreceptor were unlikely to occur, and it was possible to form the roller main body of the conductive roller having favorable characteristics as a rubber.

However, based on the results of Examples 1 to 13, and Comparative Examples 5 to 8, it was found that, in order to obtain the above effects, it was necessary that the proportion of the LIR be 3 parts by mass or more and 15 parts by mass or less with respect to 100 parts by mass of the total amount of the rubbers, and the total amount of fillers be 3 parts by mass or more and 30 parts by mass or less with respect to 100 parts by mass of the total amount of the rubbers.

In addition, based on the results of Examples 1 to 6 and Examples 8 to 11, it was found that it was preferable that the proportion of the LIR be 5 parts by mass or more and 10 parts by mass or less within the above range with respect to 100 parts by mass of the total amount of the rubbers, and it was preferable that the total proportion of zinc oxide and hydrotalcites within fillers be 3 parts by mass or more and 15 parts by mass or less with respect to 100 parts by mass of the total amount of the rubbers.

Based on the results of Examples 1 to 4, and Examples 8 to 11, it was found that it was preferable that LIR have a number average molecular weight Mn of 28,000 or more, 58,000 or less.

In addition, based on the results of Examples 1 and 7, it was found that EPDM may be additionally added as rubber.

What is claimed is:

1. A rubber composition for forming a roller main body of a conductive roller, comprising:
rubbers including an epichlorohydrin rubber, emulsion-polymerized styrene butadiene rubber, and liquid polyisoprene rubber; and
3 parts by mass or more and 30 parts by mass or less of fillers with respect to 100 parts by mass of the total amount of the rubbers,
wherein a proportion of the liquid polyisoprene rubber is 3 parts by mass or more and 15 parts by mass or less with respect to 100 parts by mass of the total amount of the rubbers.

2. The rubber composition according to claim 1,
wherein the liquid polyisoprene rubber has a number average molecular weight Mn of 28,000 or more and 58,000 or less.

3. The rubber composition according to claim 1,
wherein the fillers include zinc oxide and hydrotalcites, and a total proportion of the zinc oxide and the hydrotalcites is 3 parts by mass or more and 15 parts by mass or less with respect to 100 parts by mass of the total amount of the rubbers.

4. A conductive roller comprising a roller main body constituted by the rubber composition according to claim 1.

5. The rubber composition according to claim 2,
wherein the fillers include zinc oxide and hydrotalcites, and a total proportion of the zinc oxide and the hydrotalcites is 3 parts by mass or more and 15 parts by mass or less with respect to 100 parts by mass of the total amount of the rubbers.

6. A conductive roller comprising a roller main body constituted by the rubber composition according to claim 2.

7. A conductive roller comprising a roller main body constituted by the rubber composition according to claim 3.
